(19) United States
(12) Patent Application Publication
(10) Pub. No.: US 2014/0055322 A1
(43) Pub. Date: Feb. 27, 2014

(54) DISPLAY SYSTEM AND HEAD-MOUNTED DISPLAY APPARATUS

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/590,466

(22) Filed: Aug. 21, 2012

(51) Int. Cl. G09G 5/00

(52) U.S. Cl. 345/5

(57) ABSTRACT

A display system is provided. The display system includes a display device displaying images and a head-mounted display apparatus. The display device includes an invisible light emitting unit producing invisible lights corresponding to the images. The head-mounted display apparatus includes a visible light filtering unit and a light wavelength transforming unit. The visible light filtering unit receives lights corresponding to the display device and removes visible lights from the receiving lights, wherein the visible lights are ambient lights between the display device and the head-mounted display apparatus. The light wavelength transforming unit receives the receiving lights from the visible light filtering unit and transforms the wavelength of the receiving lights such that the receiving lights become visible lights. The disclosure further provides a head-mounted display apparatus for the display system.

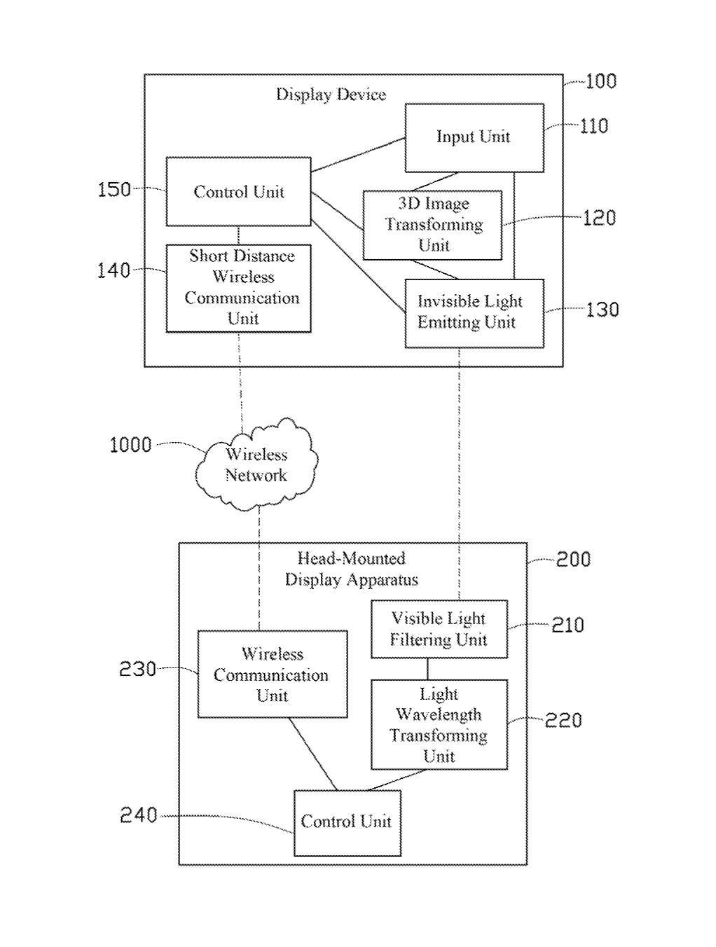

### BACKGROUND

1. Technical Field

The present disclosure relates to a display system, and particularly to a display system capable of preventing interference from ambient light.

2. Description of Related Art

In large spaces such as movie theaters, exit indicator lights are always on even when the movie is showing. However, the light of the exit indicators is annoying in the dark, and can affect the visual effect. In addition, in other spaces such as living rooms or meeting rooms which show video while lamplight is needed, the proper illumination is difficult to determine.

What is needed, therefore, is a display system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a block diagram of an embodiment of a display system of the present disclosure.

### DETAILED DESCRIPTION

The FIGURE is a block diagram of an embodiment of a display system of the present disclosure. The display system includes a display device 100 and a head-mounted display apparatus 200. The display device 100 is a display device such as a television, which is for displaying images such as videos or still images, which includes an input unit 110, a 3D image transforming unit 120, an invisible light emitting unit 130, a wireless communication unit 140, and a control unit 150 for controlling the input unit 110, the 3D image transforming unit 120, the invisible light emitting unit 130, the wireless communication unit 140.

The input unit 110 inputs the images from, for example, a multimedia player or a computer. In the illustrated embodiment, the 3D image transforming unit 120 transforms the images into 3D images such as videos or still images. The invisible light emitting unit 130 produces invisible lights corresponding to the images received from the 3D image transforming unit 120, wherein the frequencies of the invisible lights are between 120 THz and 400 THz which corresponds to near infrared. The invisible light emitting unit 130 includes ultrared light emitting diodes. In other embodiments, the invisible light emitting unit 130 is unnecessary, and the invisible light emitting unit 130 can produce invisible lights corresponding to the images received from the input unit 110. The invisible light emitting unit 130 can include other types of devices, which are capable of producing invisible light, while the frequencies of the invisible light can be within other ranges. The display device 100 communicates with the head-mounted display apparatus 200 through the wireless communication unit 140.

The head-mounted display apparatus 200 includes a visible light filtering unit 210, a light wavelength transforming unit 220, a wireless communication unit 230, and a control unit 240 controlling the visible light filtering unit 210, the light wavelength transforming unit 220, and the wireless communication unit 230. The head-mounted display apparatus 200 is a portable device such as eyeglasses or helmets. The visible light filtering unit 210 receives lights corresponding to the display device 100 and removes visible lights which are ambient lights between the display device 100 and the head-mounted display apparatus 200 from the receiving lights. In the illustrated embodiment, the visible light filtering unit 210 includes an infrared transmittance filter. The wireless communication unit 230 receives mapping information of the wavelength of the invisible lights and the visible lights from the display device 100 through a wireless network 1000. The wireless network 1000 is a short distance wireless network implemented according to BLUETOOTH telecommunication standard. In other embodiments, the visible light filtering unit 210 can include other type of light filter. The short distance wireless network 1000 can be implemented according to other telecommunication standards such as near field communication (NFC) or WI-FI.

The light wavelength transforming unit 220 receives the lights from the visible light filtering unit 210 and transforms the wavelength of the lights according to the mapping information, such that the lights become visible lights which correspond to the images. Consequently, a user can view the images through the head-mounted display apparatus 200. In the illustrated embodiment, the light wavelength transforming unit 220 is implemented through a nonlinear crystal structure which controls the polarization of the lights to change the frequencies of the lights when the lights get through nonlinear crystals. In other embodiments, the light wavelength transforming unit 220 can be implemented through other structures, for instance, a structure with lens or nano-particles.

The display system prevents interference from ambient light by using a display device producing invisible lights and a head-mounted display apparatus capable of transforming the invisible lights into visible lights.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display system, comprising:
a display device displaying images, the display device comprising:
invisible light emitting unit producing invisible lights corresponding to the images; and
a head-mounted display apparatus, comprising:
a visible light filtering unit receiving lights corresponding to the display device and removing visible lights from the receiving lights, wherein the visible lights are ambient lights between the display device and the head-mounted display apparatus; and
a light wavelength transforming unit receiving the receiving lights from the visible light filtering unit and transforming the wavelength of the receiving lights such that the receiving lights become visible lights.

2. The display system of claim 1, wherein the head-mounted display apparatus receives mapping information of the wavelength of the invisible lights and the visible lights from the display device through a wireless network, the light wavelength transforming unit transforms the wavelength of the receiving lights according to the mapping information.

3. The display system of claim 1, wherein the invisible light emitting unit comprises ultrared light emitting diodes.

4. The display system of claim 3, wherein the visible light filtering unit comprises infrared transmittance filter.

5. The display system of claim 1, wherein the frequencies of the invisible light are between 120 THz and 400 THz.

6. A head-mounted display apparatus for viewing images of invisible lights displayed on a display device, comprising:
a visible light filtering unit receiving lights corresponding to the display device and removing visible lights from the receiving lights, wherein the visible lights are ambient lights between the display device and the head-mounted display apparatus; and
a light wavelength transforming unit receiving the receiving lights from the visible light filtering unit and transforming the wavelength of the receiving lights such that the receiving lights become visible lights.

7. The head-mounted display apparatus of claim 6, wherein the head-mounted display apparatus receives mapping information of the wavelength of the invisible lights and the visible lights from the display device through a wireless network, the light wavelength transforming unit transforms the wavelength of the receiving lights according to the mapping information.

8. The head-mounted display apparatus of claim 6, wherein the invisible light emitting unit comprises ultrared light emitting diodes.

9. The head-mounted display apparatus of claim 8, wherein the visible light filtering unit comprises infrared transmittance filter.

10. The head-mounted display apparatus of claim 6, wherein the frequencies of the invisible light are between 120 THz and 400 THz.
